(19) United States
(12) Patent Application Publication
(10) Pub. No.: US 2007/0001777 A1
(43) Pub. Date: Jan. 4, 2007

(54) Normal mode noise suppressing circuit

(75) Inventors: Masaru Wasaki, Chiba (JP); Hitomi Wasaki, Chiba (JP); Yoshihiro Saitoh, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/553,752

(22) PCT Filed: Apr. 23, 2004
(86) PCT No.: PCT/JP04/05883

§ 371 Date: Oct. 18, 2005

(30) Foreign Application Priority Data
Apr. 24, 2003 (JP) 2003119289

(51) Int. Cl. H04B 3/28

(52) U.S. Cl. 333/12

(57) ABSTRACT

A normal mode noise suppressing circuit comprises: a noise suppressing section (10) provided on conductor lines (3, 4); and a capacitor (31) having an end connected to the conductor line (3) and the other end connected to the conductor line (4). The noise suppressing section (10) comprises: a winding (15a) inserted to the conductor line (3); a winding (15b) coupled to the winding (15a) through a magnetic core (15c); an injection signal transmission path (19); a capacitor (16); and an inductance element (18). The injection signal transmission path (19) has an end connected to the conductor line (3) and the other end connected to the conductor line (4). The winding (15b) and the capacitor (16) are inserted somewhere along the injection signal transmission path (19). The inductance element (18) is inserted to the conductor line (3) at a point between the winding (15a) and the node between the injection signal transmission path (19) and the conductor line (3).

### TECHNICAL FIELD

The present invention relates to a normal mode noise suppressing circuit for suppressing normal mode noise transmitted through conductor lines.

### BACKGROUND ART

Power electronics apparatuses such as a switching power supply, an inverter and a lighting circuit of a lighting fixture incorporate a power transformer circuit for transforming power. The power transformer circuit incorporates a switching circuit for transforming a direct current to an alternating current having rectangular waves. Consequently, the power transformer circuit develops a ripple voltage having a frequency equal to the switching frequency of the switching circuit, and noise resulting from the switching operation of the switching circuit. Such a ripple voltage and noise affect other apparatuses. It is therefore required to provide a means for reducing the ripple voltage and noise between the power transformer circuit and the other apparatuses or lines.

LC filters, that is, filters each incorporating an inductance element (an inductor) and a capacitor, are often used as a means for reducing a ripple voltage and noise. The LC filters include a T filter and a π filter, in addition to the one incorporating an inductance element and a capacitor. A typical noise filter for suppressing electromagnetic interference (EMI) is a type of LC filters, too. A typical EMI filter is made up of a combination of discrete elements such as a common mode choke coil, a normal mode choke coil, an X capacitor, and a Y capacitor.

Recently, power-line communications have been developed as a potential communications technique used for creating communications networks in homes. Through the power-line communications, high-frequency signals are superimposed on a power line to perform communications. When the power-line communications are performed, noise emerges on the power line because of the operations of various electric and electronic apparatuses connected to the power line, which causes a reduction in quality of communications, such as an increase in error rate. It is therefore required to provide a means for reducing noise on the power line. Moreover, it is required for the power-line communications to prevent communications signals on an indoor power line from leaking to an outdoor power line. The LC filters are used as a means for reducing noise on the power line and for preventing communications signals on the indoor power line from leaking to the outdoor power line as thus described, too.

There are two types of noise propagating along two conductor lines: one is normal mode noise that creates a potential difference between the two conductor lines, while the other is common mode noise that propagates along the two conductor lines with identical phases.

The Published Unexamined Japanese Patent Application Heisei 9-102723 (1997) discloses a line filter using a transformer. The line filter comprises the transformer and a filter circuit. The transformer incorporates a secondary winding inserted to one of two conductor lines for transmitting power from an alternating power supply to a load. The filter circuit has two inputs connected to ends of the alternating power supply, and two outputs connected to ends of a primary winding of the transformer. In the line filter, the filter circuit extracts noise components from the supply voltage and supplies the noise components to the primary winding of the transformer, so that the noise components are subtracted from the supply voltage on the conductor line to which the secondary winding of the transformer is inserted. This line filter reduces normal mode noise.

The conventional LC filters have a problem that, since the filters have a specific resonant frequency determined by the inductance and the capacitance, a desired amount of attenuation is obtained only within a narrow frequency range.

It is required for a filter inserted to a conductor line for power transfer that a desired characteristic is obtained while a current for power transfer flows and that a measure is taken against an increase in temperature. Therefore, a ferrite core having a gap is typically employed as a magnetic core in an inductance element of a filter for a power transformer circuit. However, such an inductance element has a problem that the characteristic thereof becomes close to the characteristic of an air-core inductance element, so that the inductance element is increased in size to implement a desired characteristic.

According to the line filter disclosed in the Published Unexamined Japanese Patent Application Heisei 9-102723, it is theoretically possible to remove noise components completely as long as the impedance of the filter circuit is zero and the coupling coefficient of the transformer is 1. In practice, however, it is impossible that the impedance of the filter circuit is zero. Furthermore, the impedance changes in response to the frequency. If the filter circuit is made up of a capacitor, in particular, the capacitor and the primary winding of the transformer make up a series resonant circuit. Hence, the impedance of a signal path including the capacitor and the primary winding of the transformer is reduced only in a narrow frequency range around the resonant frequency of the series resonant circuit. As a result, this line filter is capable of reducing noise components only in a narrow frequency range. In addition, the coupling coefficient of the transformer is smaller than 1 in practice. Therefore, noise components supplied to the primary winding of the transformer are not completely subtracted from the supply voltage. Because of these facts, the line filter actually fabricated has a problem that it is impossible to effectively reject noise components in a wide frequency range.

When communications are performed by superimposing normal mode signals around 100 dBμV on a power line as in the case of power-line communications, it is inevitable to install a filter circuit having a high attenuation factor to prevent normal mode signals from affecting electronic apparatuses other than communications apparatuses.

In cases where a supply circuit including an anti-harmonic circuit, an inverter control apparatus including a motor drive circuit, or a lighting fixture that performs phase control, for example, is connected to a power line, large normal mode noise emerges on the power line since a switching circuit is directly connected to the power line. Therefore, it is inevitable to install a filter circuit having a high attenuation factor in such cases, too.

### DISCLOSURE OF THE INVENTION

It is an object of the invention to provide a normal mode noise suppressing circuit having a high property of attenuating normal mode noise in a wide frequency range.

A normal mode noise suppressing circuit of the invention is one for suppressing normal mode noise that is transmitted through a first conductor line and a second conductor line and that creates a potential difference between the conductor lines. The noise suppressing circuit comprises: at least one noise suppressing section suppressing normal mode noise; and at least one capacitor for suppressing noise having an end connected to the first conductor line and the other end connected to the second conductor line.

The at least one noise suppressing section incorporates: a first detection/injection section and a second detection/injection section that are connected to the first conductor line at different points and that each perform detection of a signal corresponding to normal mode noise or injection of an injection signal for suppressing normal mode noise; and an injection signal transmission path that connects the first and second detection/injection sections to each other through a path different from the first and second conductor lines and that transmits the injection signal.

In the normal mode noise suppressing circuit of the invention, when the first detection/injection section performs the detection of the signal corresponding to the normal mode noise, the second detection/injection section injects to the first conductor line the injection signal generated based on the signal detected. When the second detection/injection section performs the detection of the signal corresponding to the normal mode noise, the first detection/injection section injects to the first conductor line the injection signal generated based on the signal detected.

In the normal mode noise suppressing circuit of the invention, the at least one noise suppressing section may be one in number, the at least one capacitor for suppressing noise may be two in number, the two being located at different points, and the noise suppressing section may be located between the two capacitors for suppressing noise.

In the normal mode noise suppressing circuit of the invention, the at least one noise suppressing section may be two in number, the two being located at different points, the at least one capacitor for suppressing noise may be one in number, and the capacitor for suppressing noise may be located between the two noise suppressing sections.

In the normal mode noise suppressing circuit of the invention, the at least one noise suppressing section may be two in number, the two being located at different points, the at least one capacitor for suppressing noise may be two in number, the two being located at different points, and the noise suppressing sections and the capacitors may be alternately located.

In the normal mode noise suppressing circuit of the invention, the first detection/injection section may incorporate: a first inductance element inserted to the first conductor line at a specific first point; and a second inductance element coupled to the first inductance element. In addition, the injection signal transmission path may include a capacitor for detection and injection that allows the injection signal to pass, and the injection signal transmission path may have an end connected to the first conductor line at a second point different from the first point and the other end connected to the second conductor line. In addition, the second inductance element may be inserted somewhere along the injection signal transmission path, and the node between the injection signal transmission path and the first conductor line may form the second detection/injection section. In this case, the at least one noise suppressing section may further incorporate a peak value reducing section that is provided between the first and second detection/injection sections on the first conductor line and that reduces a peak value of the normal mode noise.

In the normal mode noise suppressing circuit of the invention, the first detection/injection section may incorporate: a first inductance element inserted to the first conductor line at a specific first point; a second inductance element coupled to the first inductance element; a third inductance element inserted to the second conductor line at a point corresponding to the first point; and a fourth inductance element coupled to the third inductance element. In addition, the injection signal transmission path may include a capacitor for detection and injection that allows the injection signal to pass, and the injection signal transmission path may have an end connected to the first conductor line at a second point different from the first point and the other end connected to the second conductor line at a point corresponding to the second point. Furthermore, the second and fourth inductance elements may be inserted in series somewhere along the injection signal transmission path, and the node between the injection signal transmission path and the first conductor line and the node between the injection signal transmission path and the second conductor line may form the second detection/injection section. In this case, the at least one noise suppressing section may further incorporate a peak value reducing section that is provided between the first and second detection/injection sections on the first and second conductor lines and that reduces a peak value of the normal mode noise.

Other and further objects, features and advantages of the invention will appear more fully from the following description.

### BRIEF DESCRIPTION OF THE DRAWINGS

FIG. 1 is a schematic diagram illustrating a first example of configuration of a normal mode noise suppressing circuit of an embodiment of the invention.

FIG. 2 is a schematic diagram illustrating a second example of configuration of the normal mode noise suppressing circuit of the embodiment of the invention.

FIG. 3 is a schematic diagram illustrating a third example of configuration of the normal mode noise suppressing circuit of the embodiment of the invention.

FIG. 4 is a schematic diagram illustrating a fourth example of configuration of the normal mode noise suppressing circuit of the embodiment of the invention.

FIG. 5 is a block diagram illustrating a basic configuration of a cancellation-type noise suppressing circuit.

FIG. 6 is a schematic diagram illustrating a first example of specific configuration of the cancellation-type noise suppressing circuit.

FIG. 7 is a schematic diagram illustrating a second example of specific configuration of the cancellation-type noise suppressing circuit.

FIG. 8 is a schematic diagram illustrating a third example of specific configuration of the cancellation-type noise suppressing circuit.

FIG. 9 is a schematic diagram illustrating a fourth example of specific configuration of the cancellation-type noise suppressing circuit.

FIG. 10 is a schematic diagram illustrating a fifth example of specific configuration of the cancellation-type noise suppressing circuit.

FIG. 11 is a schematic diagram illustrating a sixth example of specific configuration of the cancellation-type noise suppressing circuit.

FIG. 12 is a schematic diagram illustrating a seventh example of specific configuration of the cancellation-type noise suppressing circuit.

FIG. 13 is a schematic diagram illustrating an eighth example of specific configuration of the cancellation-type noise suppressing circuit.

FIG. 14 is a plot showing an example of transmission characteristics of the normal mode noise suppressing circuit of the embodiment of the invention.

### BEST MODE FOR CARRYING OUT THE INVENTION

A preferred embodiment of the invention will now be described in detail with reference to the accompanying drawings. A noise suppressing technique employed in the embodiment of the invention will now be described. A cancellation-type noise suppressing circuit is used in the embodiment. Reference is made to FIG. 5 to describe a basic configuration and operation of the cancellation-type noise suppressing circuit.

As shown in FIG. 5, the cancellation-type noise suppressing circuit comprises: two detection/injection sections 102 and 103 connected to a conductor line 101 at different points; an injection signal transmission path 104 that connects the two detection/injection sections 102 and 103 to each other through a path different from the conductor line 101; and a peak value reducing section 105 provided between the detection/injection sections 102 and 103 on the conductor line 101.

Each of the detection/injection sections 102 and 103 performs detection of a signal corresponding to noise or injection of an injection signal for suppressing noise. The injection signal transmission path 104 transmits injection signals. The peak value reducing section 105 reduces a peak value of noise. The detection/injection section 102 incorporates an inductance element, for example. The injection signal transmission path 104 includes, for example, a high-pass filter made up of a capacitor. The peak value reducing section 105 incorporates an impedance element such as an inductance element.

In the cancellation-type noise suppressing circuit of FIG. 5, if a noise source is located at a point closer to the point B than the point A except a point located somewhere between the points A and B, the detection/injection section 103 detects a signal corresponding to noise on the conductor line 101 at the point B, and generates an injection signal to be injected to the conductor line 101, based on the signal detected, to suppress the noise on the conductor line 101. This injection signal is sent to the detection/injection section 102 through the transmission path 104. The detection/injection section 102 injects the injection signal to the conductor line 101 such that the signal has a phase opposite to that of the noise on the conductor line 101. As a result, the noise on the conductor line 101 is cancelled out by the injection signal, and noise is suppressed along a portion of the conductor line 101 from the point A onward along the direction of travel of the noise. In the present patent application, noise includes unwanted signals, too.

In the cancellation-type noise suppressing circuit of FIG. 5, if a noise source is located at a point closer to the point A than the point B except a point located somewhere between the points A and B, the detection/injection section 102 detects a signal corresponding to noise on the conductor line 101 at the point A, and generates an injection signal to be injected to the conductor line 101, based on the signal detected, to suppress the noise on the conductor line 101. This injection signal is sent to the detection/injection section 103 through the transmission path 104. The detection/injection section 103 injects the injection signal to the conductor line 101 such that the signal has a phase opposite to that of the noise on the conductor line 101. As a result, the noise on the conductor line 101 is cancelled out by the injection signal, and noise is suppressed along a portion of the conductor line 101 from the point B onward along the direction of travel of the noise.

The peak value reducing section 105 reduces a peak value of noise passing through the conductor line 101 between the points A and B. As a result, the difference is reduced between the peak value of the noise propagating through the conductor line 101 and the peak value of the injection signal injected to the conductor line 101 through the transmission path 104.

According to the cancellation-type noise suppressing circuit, it is possible to effectively suppress noise in a wide frequency range.

The cancellation-type noise suppressing circuit may be designed without the peak value reducing section 105. However, if the noise suppressing circuit includes the peak value reducing section 105, it is possible to suppress noise in a wider frequency range as compared with the case where the noise suppressing circuit does not include the peak value reducing section 105.

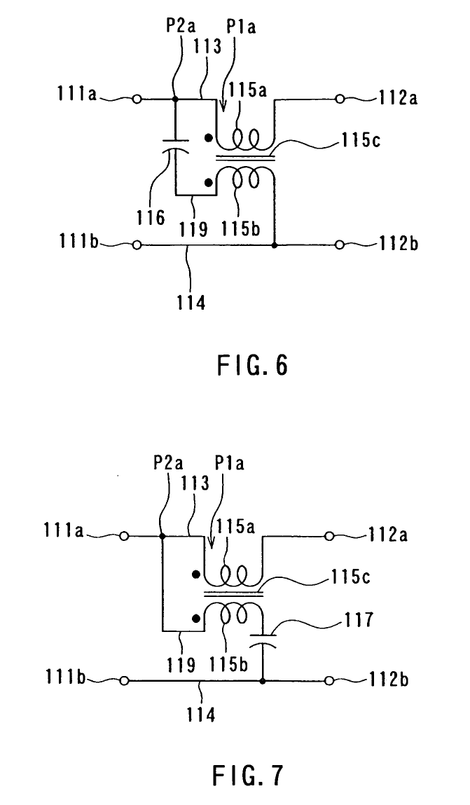

Reference is now made to FIG. 6 to FIG. 13 to describe first to eighth examples of specific configuration of the cancellation-type noise suppressing circuit for suppressing normal mode noise. First, reference is made to FIG. 6 and FIG. 7 to describe the first and second examples of configuration of the cancellation-type noise suppressing circuit.

The cancellation-type noise suppressing circuit of the first example shown in FIG. 6 comprises: a pair of terminals 111a and 111b; another pair of terminals 112a and 112b; a conductor line 113 connecting the terminal 111a to the terminal 112a; and a conductor line 114 connecting the terminal 111b to the terminal 112b. The noise suppressing circuit further comprises: a winding 115a inserted to the conductor line 113 at a specific first point P1a; a magnetic core 115c; a winding 115b coupled to the winding 115a through the core 115c; and an injection signal transmission path 119. The injection signal transmission path 119 has an end connected to the conductor line 113 at a point different from the first point P1a, that is, to be specific, a second point P2a located between the winding 115a and the terminal 111a. The injection signal transmission path 119 has the other end connected to the conductor line 114. The winding 115b is inserted somewhere along the injection signal transmission path 119. A capacitor 116 is provided somewhere along the injection signal transmission path 119. The capacitor 116 is located between the winding 115b and the node between the injection signal transmission path 119 and the conductor line 113.

In the cancellation-type noise suppressing circuit of FIG. 6, the windings 115a and 115b and the core 115c correspond to the detection/injection section 102 of FIG. 5. The winding 115a corresponds to the first inductance element of the invention. The winding 115b corresponds to the second inductance element of the invention. The node between the injection signal transmission path 119 and the conductor line 113 forms the detection/injection section 103 of FIG. 5. The injection signal transmission path 119 corresponds to the injection signal transmission path 104 of FIG. 5. The capacitor 116 corresponds to the capacitor for detection and injection of the invention. The noise suppressing circuit of FIG. 6 does not incorporate the peak value reducing section 105 of FIG. 5.

The operation of the cancellation-type noise suppressing circuit of FIG. 6 will now be described. If normal mode noise is received at each of the terminals 111a and 111b, the capacitor 116 detects a signal corresponding to the normal mode noise at the second point P2a. Furthermore, the capacitor 116 generates an injection signal having a phase opposite to that of the normal mode noise, based on the signal detected. The injection signal is supplied to the winding 115b through the transmission path 119. The winding 115b injects the injection signal to the conductor line 113 through the winding 115a. As a result, normal mode noise is suppressed along a portion of the conductor line 113 from the first point P1a onward along the direction of travel of the normal mode noise.

If normal mode noise is received at each of the terminals 112a and 112b, the winding 115b detects through the winding 115a a signal corresponding to the normal mode noise at the first point P1a. Furthermore, an injection signal is generated based on the signal detected. The injection signal is injected to the conductor line 113 through the capacitor 116, such that the injection signal has a phase opposite to that of the normal mode noise. As a result, normal mode noise is suppressed along a portion of the conductor line 113 from the second point P2a onward along the direction of travel of the normal mode noise. As thus described, the effect of suppressing noise of the noise suppressing circuit of FIG. 6 remains the same, regardless of the direction of travel of noise.

The cancellation-type noise suppressing circuit of the second example shown in FIG. 7 comprises a capacitor 117 in place of the capacitor 116 of the noise suppressing circuit of FIG. 6. The capacitor 117 is inserted to the transmission path 119 at a point between the winding 115b and the node between the transmission path 119 and the conductor line 114. The operation and effect of the noise suppressing circuit of FIG. 7 are the same as those of the noise suppressing circuit of FIG. 6. As thus described, the noise suppressing circuits of the first and second examples shown in FIG. 6 and FIG. 7 are equivalent to each other in terms of function.

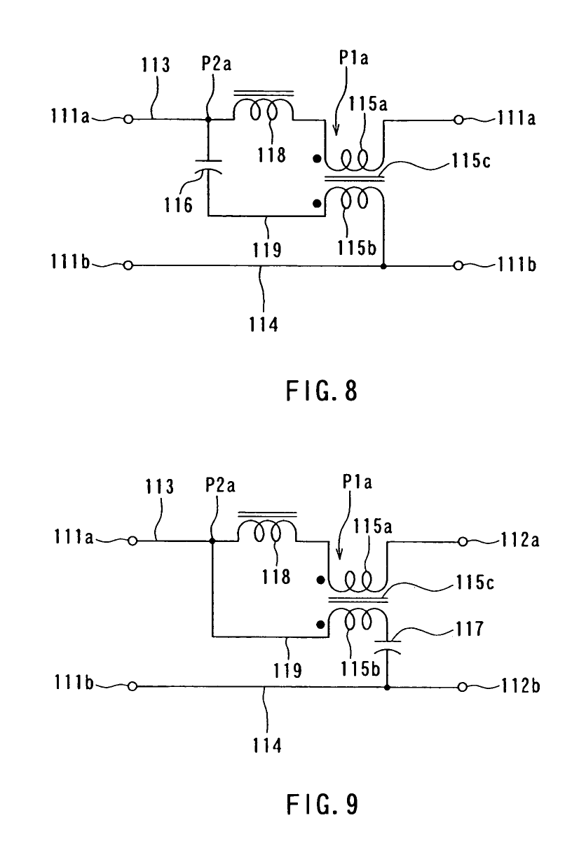

Reference is now made to FIG. 8 and FIG. 9 to describe the third and fourth examples of specific configuration of the cancellation-type noise suppressing circuit.

The cancellation-type noise suppressing circuit of the third example shown in FIG. 8 has a configuration in which an inductance element 118 is added to the noise suppressing circuit of the first example of FIG. 6. The inductance element 118 is inserted to the conductor line 113 at a point between the first point P1a and the second point P2a. The inductance element 118 corresponds to the peak value reducing section 105 of FIG. 5.

In the noise suppressing circuit of FIG. 8, the inductance element 118 reduces the peak value of normal mode noise passing through the conductor line 113 between the first point P1a and the second point P2a. The difference is thereby reduced between the peak value of the normal mode noise propagating via the conductor line 113 and the peak value of the injection signal injected to the conductor line 113 via the transmission path 119. The remainder of operation and effect of the noise suppressing circuit of FIG. 8 are the same as those of the noise suppressing circuit of FIG. 6.

The cancellation-type noise suppressing circuit of the fourth example shown in FIG. 9 comprises the capacitor 117 in place of the capacitor 116 of the noise suppressing circuit of FIG. 8. The capacitor 117 is inserted to the transmission path 119 at a point between the winding 115b and the node between the transmission path 119 and the conductor line 114. The operation and effect of the noise suppressing circuit of FIG. 9 are the same as those of the noise suppressing circuit of FIG. 8. As thus described, the noise suppressing circuits of the third and fourth examples shown in FIG. 8 and FIG. 9 are equivalent to each other in terms of function.

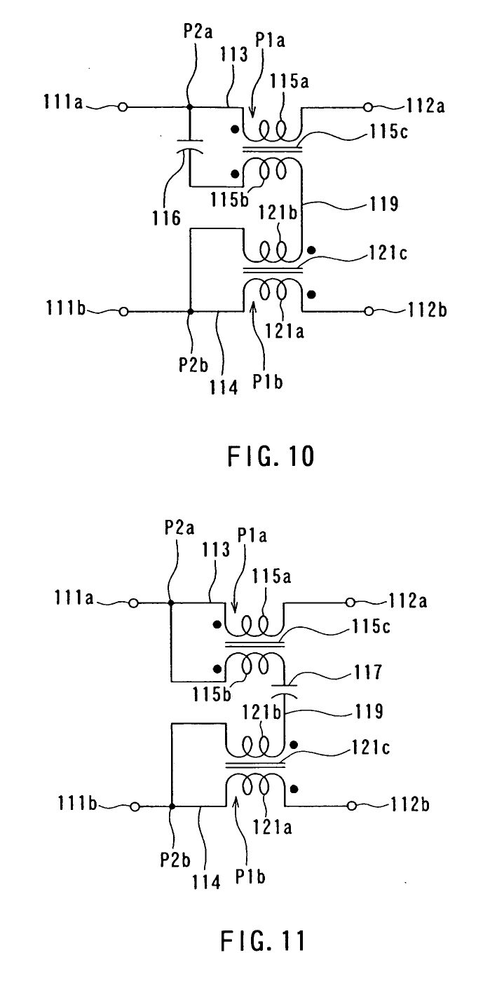

Reference is now made to FIG. 10 and FIG. 11 to describe the fifth and sixth examples of specific configuration of the cancellation-type noise suppressing circuit.

The noise suppressing circuit of the fifth example shown in FIG. 10 has a configuration in which windings 121a and 121b and a magnetic core 121c are added to the noise suppressing circuit of the first example of FIG. 6. In the fifth example, the winding 121a is inserted to the conductor line 114 at a point P1b corresponding to the first point P1a. The winding 121b is coupled to the winding 121a through the core 121c. In the fifth example, an end of the transmission path 119 is connected to the conductor line 113 at the second point P2a. The other end of the transmission path 119 is connected to the conductor line 114 at a point P2b corresponding to the second point P2a. The windings 115b and 121b are inserted in series somewhere along the transmission path 119. The capacitor 116 is inserted to the transmission path 119 at a point between the winding 115b and the node between the transmission path 119 and the conductor line 113. The cores 115c and 121c may be a single core.

In the noise suppressing circuit of FIG. 10, the windings 115a and 115b, the core 115c, the windings 121a and 121b, and the core 121c correspond to the detection/injection section 102 of FIG. 5. The winding 115a corresponds to the first inductance element of the invention. The winding 115b corresponds to the second inductance element of the invention. The winding 121a corresponds to the third inductance element of the invention. The winding 121b corresponds to the fourth inductance element of the invention. The node between the transmission path 119 and the conductor line 113 and the node between the transmission path 119 and the conductor line 114 form the detection/injection section 103 of FIG. 5. The transmission path 119 corresponds to the transmission path 104 of FIG. 5. The capacitor 116 corresponds to the capacitor for detection and injection of the invention. The noise suppressing circuit of FIG. 10 does not incorporate the peak value reducing section 105 of FIG. 5.

The operation of the cancellation-type noise suppressing circuit of FIG. 10 will now be described. If normal mode noise is received at each of the terminals 111a and 111b, the capacitor 116 detects a signal corresponding to the normal mode noise at the points P2a and P2b. Furthermore, the capacitor 116 generates an injection signal having a phase opposite to that of the normal mode noise, based on the signal detected. The injection signal is supplied to the windings 115b and 121b through the transmission path 119. The windings 115b and 121b inject the injection signal to the conductor lines 113 and 114 through the windings 115a and 121a, respectively. The injection signal injected to the conductor line 113 has a phase opposite to that of the normal mode noise propagating through the conductor line 113. The injection signal injected to the conductor line 114 has a phase opposite to that of the normal mode noise propagating through the conductor line 114. As a result, normal mode noise is suppressed along portions of the conductor lines 113 and 114 from the points P1a and P1b onward along the direction of travel of the normal mode noise.

If normal mode noise is received at each of the terminals 112a and 112b, the windings 115b and 121b detect through the windings 115a and 121a a signal corresponding to the normal mode noise at the points P1a and P1b. Furthermore, an injection signal is generated based on the signal detected. The injection signal is injected to the conductor lines 113 and 114, such that the injection signal has a phase opposite to that of the normal mode noise. As a result, normal mode noise is suppressed along portions of the conductor lines 113 and 114 from the points P2a and P2b onward along the direction of travel of the normal mode noise. As thus described, the effect of suppressing noise of the noise suppressing circuit of FIG. 10 remains the same, regardless of the direction of travel of noise.

The noise suppressing circuit of FIG. 10 has such a configuration that the impedance characteristics of the conductor lines 113 and 114 are balanced. As a result, this noise suppressing circuit is capable of suppressing an increase in radiation field strength from the conductor lines 113 and 114 and thereby suppressing an emergence of emission noise.

The cancellation-type noise suppressing circuit of the sixth example shown in FIG. 11 comprises the capacitor 117 in place of the capacitor 116 of the noise suppressing circuit of FIG. 10. The capacitor 117 is inserted to the transmission path 119 at a point between the windings 115b and 121b. The operation and effect of the noise suppressing circuit of FIG. 11 are the same as those of the noise suppressing circuit of FIG. 10. As thus described, the noise suppressing circuits of the fifth and sixth examples shown in FIG. 10 and FIG. 11 are equivalent to each other in terms of function.

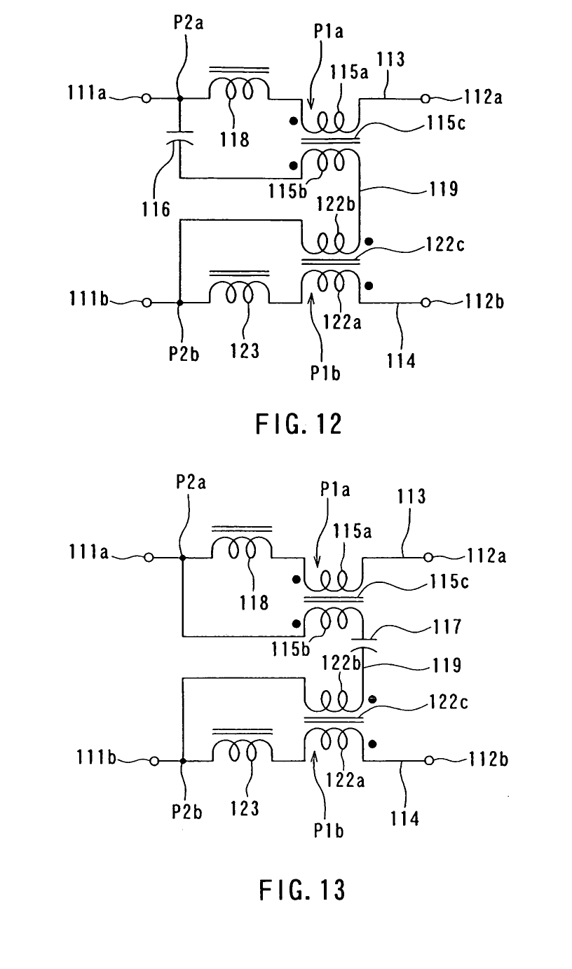

Reference is now made to FIG. 12 and FIG. 13 to describe the seventh and eighth examples of specific configuration of the cancellation-type noise suppressing circuit.

The cancellation-type noise suppressing circuit of the seventh example shown in FIG. 12 has a configuration in which the inductance elements 118 and 123 are added to the noise suppressing circuit of the fifth example of FIG. 10. The inductance element 118 is inserted to the conductor line 113 at a point between the first point P1a and the second point P2a. The inductance element 123 is inserted to the conductor line 114 at a point between the points P1b and P2b. The inductance elements 118 and 123 correspond to the peak value reducing section 105 of FIG. 5.

In the noise suppressing circuit of FIG. 12, the inductance element 118 reduces the peak value of normal mode noise passing through the conductor line 113 between the points P1a and P2a. Similarly, the inductance element 123 reduces the peak value of normal mode noise passing through the conductor line 114 between the points P1b and P2b. The difference is thereby reduced between the peak value of the normal mode noise propagating via the conductor lines 113, 114 and the peak value of the injection signal injected to the conductor lines 113, 114 via the transmission path 119. The remainder of function and effect of the noise suppressing circuit of FIG. 12 are the same as those of the noise suppressing circuit of FIG. 10.

The cancellation-type noise suppressing circuit of the eighth example shown in FIG. 13 comprises the capacitor 117 in place of the capacitor 116 of the noise suppressing circuit of FIG. 12. The capacitor 117 is inserted to the transmission path 119 at a point between the windings 115b and 122b. The operation and effect of the noise suppressing circuit of FIG. 13 are the same as those of the noise suppressing circuit of FIG. 12. As thus described, the noise suppressing circuits of the seventh and eighth examples shown in FIG. 12 and FIG. 13 are equivalent to each other in terms of function.

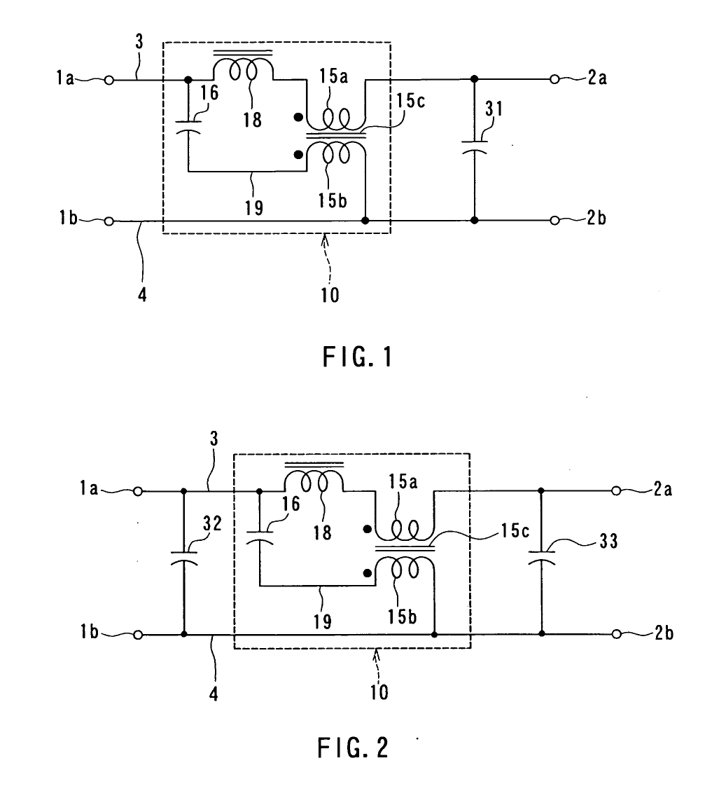

Reference is now made to FIG. 1 to FIG. 4 to describe a normal mode noise suppressing circuit (hereinafter simply called a noise suppressing circuit) of the embodiment. The noise suppressing circuit of the embodiment is a circuit for suppressing normal mode noise that is transmitted through two conductor lines and create a potential difference between these conductor lines. The noise suppressing circuit of the embodiment is made up of at least one cancellation-type noise suppressing circuit and at least one capacitor. First to fourth examples of configuration of the noise suppressing circuit of the embodiment will now be described.

FIG. 1 is a schematic diagram illustrating the first example of configuration of the noise suppressing circuit of the embodiment. The noise suppressing circuit of FIG. 1 comprises: a pair of terminals 1a and 1b; another pair of terminals 2a and 2b; a conductor line 3 connecting the terminal 1a to the terminal 2a; and a conductor line 4 connecting the terminal 1b to the terminal 2b.

The noise suppressing circuit further comprises: a noise suppressing section 10 for suppressing normal mode noise; and a capacitor 31 that is located at a point closer to the terminals 2a and 2b than the noise suppressing section 10 and has an end connected to the conductor line 3 and the other end connected to the conductor line 4. The capacitor 31 may be located closer to the terminals 1a and 1b than the noise suppressing section 10. The capacitor 31 corresponds to the capacitor for suppressing noise of the invention.

The noise suppressing section 10 is a cancellation-type noise suppressing circuit that suppresses normal mode noise. The noise suppressing section 10 may have a configuration of any of the cancellation-type noise suppressing circuits shown in FIG. 6 to FIG. 13. FIG. 1 shows an example in which the noise suppressing section 10 has a configuration of the cancellation-type noise suppressing circuit of FIG. 8.

That is, in the noise suppressing circuit of FIG. 1, the noise suppressing section 10 comprises: a winding 15a inserted to the conductor line 3; a magnetic core 15c; a winding 15b coupled to the winding 15a through the core 15c; an injection signal transmission path 19; a capacitor 16; and an inductance element 18. The windings 15a and 15b, the core 15c, the transmission path 19, the capacitor 16 and the inductance element 18 correspond to the windings 115a and 115b, the core 115c, the transmission path 119, the capacitor 116 and the inductance element 118 of FIG. 8, respectively.

FIG. 2 is a schematic diagram illustrating the second example of configuration of the noise suppressing circuit of the embodiment. The noise suppressing circuit of FIG. 2 comprises the noise suppressing section 10, a capacitor 32 and a capacitor 33. The capacitor 32 is located at a point closer to the terminals 1a and 1b than the noise suppressing section 10 and has an end connected to the conductor line 3 and the other end connected to the conductor line 4. The capacitor 33 is located at a point closer to the terminals 2a and 2b than the noise suppressing section 10 and has an end connected to the conductor line 3 and the other end connected to the conductor line 4. The noise suppressing section 10 is provided between the capacitors 32 and 33. The noise suppressing section 10 may have a configuration of any of the cancellation-type noise suppressing circuits shown in FIG. 6 to FIG. 13. FIG. 2 shows an example in which the noise suppressing section 10 has a configuration of the cancellation-type noise suppressing circuit of FIG. 8 as does the noise suppressing circuit of FIG. 1.

In the noise suppressing circuit of FIG. 2, a π filter circuit is made up of the single noise suppressing section 10 and the two capacitors 32 and 33.

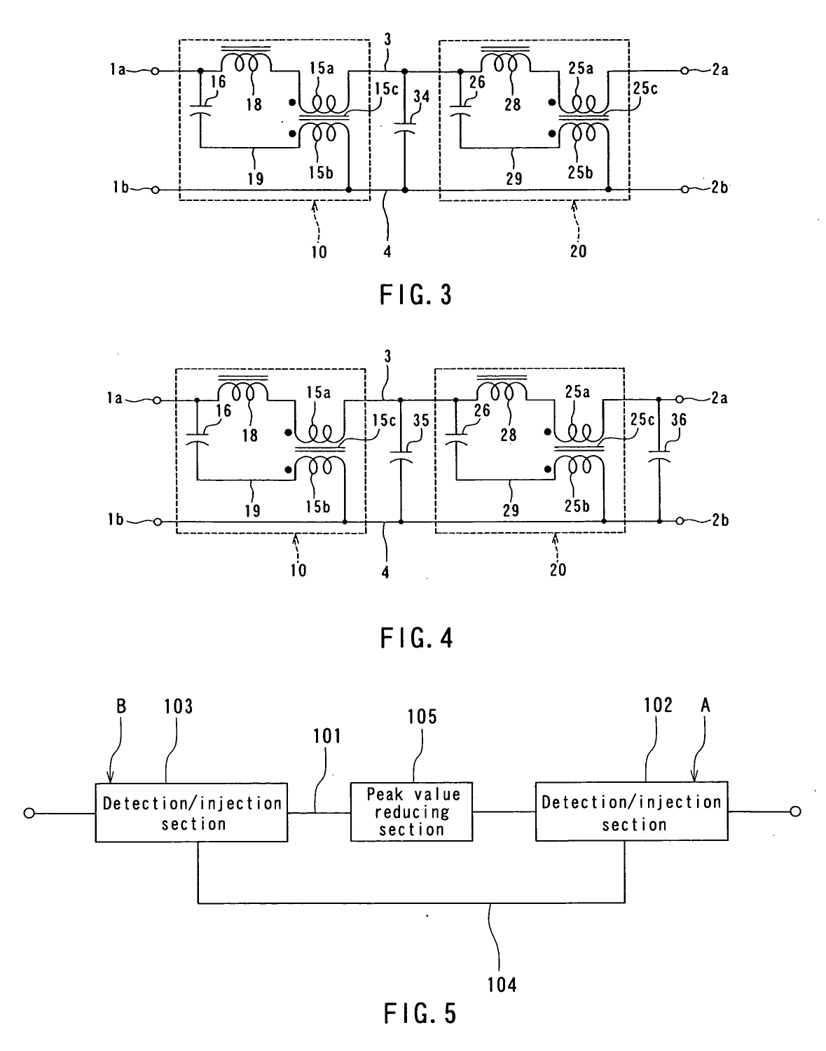

FIG. 3 is a schematic diagram illustrating the third example of configuration of the noise suppressing circuit of the embodiment. The noise suppressing circuit of FIG. 3 comprises: a first noise suppressing section 10 and a second noise suppressing section 20 that are provided at different points along the conductor lines 3 and 4 and that each suppress normal mode noise; and a capacitor 34 that is located at a point between the noise suppressing sections 10 and 20 and has an end connected to the conductor line 3 and the other end connected to the conductor line 4. The noise suppressing section 10 is located closer to the terminals 1a and 1b than the capacitor 34. The noise suppressing section 20 is located closer to the terminals 2a and 2b than the capacitor 34.

As is the noise suppressing section 10, the noise suppressing section 20 is a cancellation-type noise suppressing circuit that suppresses normal mode noise. Each of the noise suppressing sections 10 and 20 may have a configuration of any of the cancellation-type noise suppressing circuits shown in FIG. 6 to FIG. 13. The noise suppressing sections 10 and 20 may have identical configurations or different configurations. FIG. 3 shows an example in which each of the noise suppressing sections 10 and 20 has a configuration of the cancellation-type noise suppressing circuit of FIG. 8.

That is, in the noise suppressing circuit of FIG. 3, the noise suppressing section 20 comprises: a winding 25a inserted to the conductor line 3; a magnetic core 25c; a winding 25b coupled to the winding 25a through the core 25c; an injection signal transmission path 29; a capacitor 26; and an inductance element 28. The windings 25a and 25b, the core 25c, the transmission path 29, the capacitor 26 and the inductance element 28 correspond to the windings 115a and 115b, the core 115c, the transmission path 119, the capacitor 116 and the inductance element 118 of FIG. 8, respectively. The noise suppressing section 10 of the noise suppressing circuit of FIG. 3 has a configuration the same as that of the noise suppressing section 10 of FIG. 1.

In the noise suppressing circuit of FIG. 3, a T filter circuit is made up of the two noise suppressing sections 10 and 20 and the single capacitor 34.

FIG. 4 is a schematic diagram illustrating the fourth example of configuration of the noise suppressing circuit of the embodiment. The noise suppressing circuit of FIG. 4 comprises the noise suppressing sections 10 and 20, and capacitors 35 and 36. The capacitor 35 is located at a point between the noise suppressing sections 10 and 20 and has an end connected to the conductor line 3 and the other end connected to the conductor line 4. The capacitor 36 is located at a point closer to the terminals 2a and 2b than the noise suppressing section 20 and has an end connected to the conductor line 3 and the other end connected to the conductor line 4. The noise suppressing section 10 is located closer to the terminals 1a and 1b than the capacitor 35. The noise suppressing section 20 is located at a point between the capacitors 35 and 36. As thus described, the noise suppressing sections and the capacitors are alternately located in the noise suppressing circuit of FIG. 4. The capacitor 36 may be located closer to the terminals 1a and 1b than the noise suppressing section 10.

Each of the noise suppressing sections 10 and 20 may have a configuration of any of the cancellation-type noise suppressing circuits shown in FIG. 6 to FIG. 13. The noise suppressing sections 10 and 20 may have identical configurations or different configurations. FIG. 4 shows an example in which each of the noise suppressing sections 10 and 20 has a configuration of the cancellation-type noise suppressing circuit of FIG. 8. That is, the noise suppressing sections 10 and 20 of the noise suppressing circuit of FIG. 4 have configurations the same as those of the noise suppressing sections 10 and 20 of FIG. 3.

In the noise suppressing circuit of FIG. 4, a filter circuit which is a combination of a π filter circuit and a T filter circuit is made up of the two noise suppressing sections 10 and 20 and the two capacitors 35 and 36.

According to the noise suppressing circuit of the embodiment as illustrated in FIG. 1 to FIG. 4, it is possible to obtain a higher property of attenuating normal mode noise in a wide frequency range, compared with cases in which a cancellation-type noise suppressing circuit is only used. This will now be described with reference to a result of a simulation that follows.

In the simulation, transmission characteristics were obtained for the noise suppressing circuits of FIG. 1 to FIG. 4 and the cancellation-type noise suppressing circuit of FIG. 8. Frequency characteristics of gains were obtained as the transmission characteristics.

Values that will now be given were used for the simulation. The inductance of each of the windings 15a, 15b, 25a, 25b, 115a and 115b was 30 μH. The inductance of each of the inductance elements 18, 28 and 118 was 30 μH, too. The capacitance of each of the capacitors 16, 26, 31 to 36, and 116 was 0.1 μF.

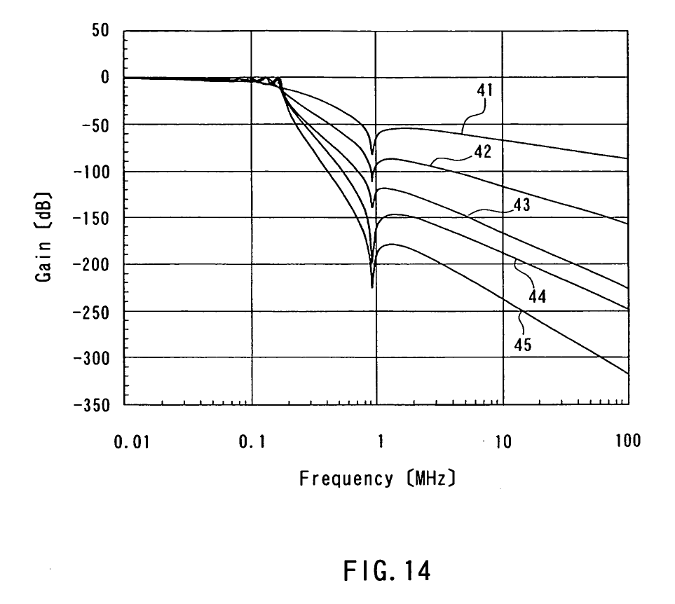

FIG. 14 shows the transmission characteristics obtained by the above-mentioned simulation. A line with numeral 41 indicates the transmission characteristic of the cancellation-type noise suppressing circuit of FIG. 8 for normal mode noise. A line with numeral 42 indicates the transmission characteristic of the noise suppressing circuit of FIG. 1 for normal mode noise. A line with numeral 43 indicates the transmission characteristic of the noise suppressing circuit of FIG. 2 for normal mode noise. A line with numeral 44 indicates the transmission characteristic of the noise suppressing circuit of FIG. 3 for normal mode noise. A line with numeral 45 indicates the transmission characteristic of the noise suppressing circuit of FIG. 4 for normal mode noise.

As shown in FIG. 14, it is noted that the noise suppressing circuits of FIG. 1 to FIG. 4 are capable of obtaining a higher property of attenuating normal mode noise in a wide frequency range, compared with the cancellation-type noise suppressing circuit of FIG. 8. As shown in FIG. 14, it is noted that, if the properties of attenuating normal mode noise are compared among the noise suppressing circuits of FIG. 1 to FIG. 4, the noise suppressing circuit of FIG. 2 has a higher property than that of the noise suppressing circuit of FIG. 1, the noise suppressing circuit of FIG. 3 has a higher property than that of the noise suppressing circuit of FIG. 2, and the noise suppressing circuit of FIG. 4 has a higher property than that of the noise suppressing circuit of FIG. 3.

Consideration will now be given to the transmission characteristics of the noise suppressing circuits in a case where, in each of the noise suppressing circuits of FIG. 1 to FIG. 4, each of the noise suppressing sections 10 and 20 has the configuration of the cancellation-type noise suppressing circuit of FIG. 12. In this case, the transmission characteristics of the noise suppressing circuits will be the same as those indicated with numerals 42 to 45 in FIG. 14 if the sum of inductances of the windings 115a, 115b and the windings 121a, 121b is equal to the inductance of the windings 15a, 15b of FIG. 8, and the sum of the inductances of the inductance elements 118 and 128 of FIG. 12 is equal to the inductance of the inductance element 118 of FIG. 8.

According to the embodiment as thus described, the noise suppressing circuit is made up of at least one cancellation-type noise suppressing circuit and at least one capacitor so as to implement the noise suppressing circuit having a high property of attenuating normal mode noise in a wide frequency range.

According to the noise suppressing circuit of the embodiment, it is possible to effectively suppress normal mode noise with a relatively simple configuration. It is thereby possible to achieve a reduction in dimensions of the noise suppressing circuit, according to the embodiment.

The noise suppressing circuit of the embodiment is capable of being used as a means for reducing ripple voltage and noise emerging from a power transformer circuit or as a means for reducing noise on a power line in power-line communications and for preventing communications signals on an indoor power line from leaking to an outdoor power line.

The present invention is not limited to the foregoing embodiment but may be practiced in still other ways. For example, the cancellation-type noise suppressing circuit used as each of the noise suppressing sections 10 and 20 may be a circuit having a configuration that is laterally symmetric to each of the cancellation-type noise suppressing circuits shown in FIG. 6 to FIG. 13. Furthermore, it is acceptable as long as the cancellation-type noise suppressing circuit used as each of the noise suppressing sections 10 and 20 has a configuration including two detection/injection sections and an injection signal transmission path, and it is possible to employ various sorts of designs other than the configurations illustrated in the embodiment.

As thus described, according to the invention, it is possible to implement the normal mode noise suppressing circuit having a high property of attenuating normal mode noise in a wide frequency range.

Obviously many modifications and variations of the present invention are possible in the light of the above teachings. It is therefore to be understood that within the scope of the appended claims the invention may be practiced otherwise than as specifically described.

1. A normal mode noise suppressing circuit for suppressing normal mode noise that is transmitted through a first conductor line and a second conductor line and that creates a potential difference between the conductor lines, the noise suppressing circuit comprising:
at least one noise suppressing section suppressing normal mode noise; and
at least one capacitor for suppressing noise having an end connected to the first conductor line and the other end connected to the second conductor line, wherein:
the at least one noise suppressing section incorporates: a first detection/injection section and a second detection/injection section that are connected to the first conductor line at different points and that each perform detection of a signal corresponding to normal mode noise or injection of an injection signal for suppressing normal mode noise; and an injection signal transmission path that connects the first and second detection/injection sections to each other through a path different from the first and second conductor lines and that transmits the injection signal;
when the first detection/injection section performs the detection of the signal corresponding to the normal mode noise, the second detection/injection section injects to the first conductor line the injection signal generated based on the signal detected; and
when the second detection/injection section performs the detection of the signal corresponding to the normal mode noise, the first detection/injection section injects to the first conductor line the injection signal generated based on the signal detected.

2. The normal mode noise suppressing circuit according to claim 1, wherein the at least one noise suppressing section is one in number, the at least one capacitor for suppressing noise is two in number, the two being located at different points, and the noise suppressing section is located between the two capacitors for suppressing noise.

3. The normal mode noise suppressing circuit according to claim 1, wherein the at least one noise suppressing section is two in number, the two being located at different points, the at least one capacitor for suppressing noise is one in number, and the capacitor for suppressing noise is located between the two noise suppressing sections.

4. The normal mode noise suppressing circuit according to claim 1, wherein the at least one noise suppressing section is two in number, the two being located at different points, the at least one capacitor for suppressing noise is two in number, the two being located at different points, and the noise suppressing sections and the capacitors for suppressing noise are alternately located.

5. The normal mode noise suppressing circuit according to claim 1, wherein the first detection/injection section incorporates: a first inductance element inserted to the first conductor line at a specific first point; and a second inductance element coupled to the first inductance element, and wherein:
the injection signal transmission path includes a capacitor for detection and injection that allows the injection signal to pass; the injection signal transmission path has an end connected to the first conductor line at a second point different from the first point and the other end connected to the second conductor line; the second inductance element is inserted somewhere along the injection signal transmission path; and a node between the injection signal transmission path and the first conductor line forms the second detection/injection section.

6. The normal mode noise suppressing circuit according to claim 5, wherein the at least one noise suppressing section further incorporates a peak value reducing section that is provided between the first and second detection/injection sections on the first conductor line and that reduces a peak value of the normal mode noise.

7. The normal mode noise suppressing circuit according to claim 1, wherein the first detection/injection section incorporates: a first inductance element inserted to the first conductor line at a specific first point; a second inductance element coupled to the first inductance element; a third inductance element inserted to the second conductor line at a point corresponding to the first point; and a fourth inductance element coupled to the third inductance element, and wherein:
the injection signal transmission path includes a capacitor for detection and injection that allows the injection signal to pass; the injection signal transmission path has an end connected to the first conductor line at a second point different from the first point and the other end connected to the second conductor line at a point corresponding to the second point; the second and fourth inductance elements are inserted in series somewhere along the injection signal transmission path; and a node between the injection signal transmission path and the first conductor line and a node between the injection signal transmission path and the second conductor line form the second detection/injection section.

8. The normal mode noise suppressing circuit according to claim 7, wherein the at least one noise suppressing section further incorporates a peak value reducing section that is provided between the first and second detection/injection sections on the first and second conductor lines and that reduces a peak value of the normal mode noise.
